(19) United States
(12) Patent Application Publication
(10) Pub. No.: US 2007/0251019 A1
(43) Pub. Date: Nov. 1, 2007

(54) Robust Slide Adjustable Wrench

(75) Inventors: Jonathan S. Beckwith, Raleigh, NC (US); Alan D. Anderson, Willow Spring, NC (US)

Correspondence Address: COATS & BENNETT, PLLC, 1400 Crescent Green, Suite 300, Cary, NC, 27518, US

(73) Assignee: COOPER BRANDS, INC., Houston, TX (US)

(21) Appl. No.: 11/770,304

(22) Filed: Jun. 28, 2007

Related U.S. Application Data
(63) Continuation of application No. 11/294,170, filed on Dec. 5, 2005.

(51) Int. Cl. B25B 13/14; B25B 13/10

(52) U.S. Cl. 7/139

(57) ABSTRACT

An adjustable wrench includes: a head having a first fixed jaw; a handle extending away from the head; a selectively positionable second jaw; an adjustment mechanism that includes a rotatable shaft, an actuator, and a gear train operatively coupling the shaft to the second jaw; the shaft having an external spiral groove and disposed at least partially in the handle; the actuator slidable relative to the handle and engaging the groove; first and second flanges spaced from one another and each circumferentially surrounding the shaft; and a retainer disposed between the flanges and engaging the shaft so as to limit movement of the shaft parallel to the handle longitudinal axis in two directions via abutment with the first and second flanges. Such a wrench may have a proof torque of at least the minimum level set forth in ASME B107.8, 2003 revision. Other wrenches are also disclosed.

This application is a continuation of prior application Ser. No. 11/294,170, filed 5 Dec. 2005, which is incorporated herein by reference.

### BACKGROUND OF THE INVENTION

The present invention is directed generally to hand tools known as adjustable wrenches, and more particularly to an adjustable wrench that employs a slide-based adjusting mechanism.

Adjustable wrenches are generally considered more convenient to use than conventional open-end jaw wrenches because they are adjustable over a range of sizes and therefore adaptable to a variety of workpiece sizes. Conventional adjustable wrenches include a fixed jaw and a moveable jaw, with movement of the moveable jaw controlled by rotation of an externally accessible adjusting worm gear. The user simply rotates the worm gear, typically by engaging the knurled outer surface thereof with their thumb, to move the moveable jaw toward or away from the fixed jaw. High quality examples of such wrenches are sold under the brand name “CRESCENT” by Cooper Industries, Inc. of Houston, Tex.

While such wrenches have gained wide acceptance, they do not always provide the desired operational “feel” and are sometimes difficult to adjust in situ. Accordingly, alternative approaches to adjustable wrenches have been proposed. For example, U.S. Pat. No. 3,901,107 to Halls discloses an adjustable wrench that uses a “tape drive” mechanism to control movement of the moveable jaw. Likewise, U.S. Pat. No. 3,640,159 to Halls et al discloses an adjustable wrench that controls the movement of the moveable jaw via a slide-based adjusting mechanism. However, these alternative designs have not proven entirely satisfactory for various reasons. As such, there remains a need for alternative designs for adjustable wrenches, advantageously designs that are robust yet simple to use.

### SUMMARY OF THE INVENTION

In one embodiment, the present invention provides an adjustable wrench, comprising: a head having a first fixed jaw; a handle extending away from the head; a second jaw selectively positionable with respect the first jaw; an adjustment mechanism controlling the positioning of the second jaw and comprising a rotatable shaft, an actuator, and a gear train operatively coupling the shaft to the second jaw. The shaft has an external spiral groove and is disposed at least partially in the handle for rotation about a shaft rotational axis. The actuator is slidable relative to the handle and engages the groove. A first flange circumferentially surrounds the shaft. A second flange also circumferentially surrounds the shaft and is longitudinally spaced from the first flange. A retainer is disposed between the flanges and engages the shaft so as to limit movement of the shaft parallel to the handle longitudinal axis in two directions via abutment of itself with the first and second flanges. The first and second flanges may be disposed between the spiral groove and the gear train. The shaft may be substantially fixed against longitudinal movement via the first flange, the second flange, and the retainer. The spiral groove may trace a helix. The gear train may comprise a rotatable worm gear operatively disposed between the shaft and the second jaw. A biasing member may bias the worm gear toward the shaft, and the biasing member may comprise a discrete spring. A retaining cap may be disposed so as to constrain axial movement of the worm gear. The first jaw may extend in a first direction generally opposite the handle; with the head further comprising a pair of spaced, generally parallel, sidewalls distal from the first jaw; with a recess defined between the sidewalls; wherein the gear train comprises a worm gear disposed substantially within the recess and having a rotational axis; the recess having a cross-sectional dimension D measured in a direction Z that is both normal to the rotational axis and generally perpendicular to the first direction; wherein the sidewalls both have a thickness in direction Z of about 25% D or more. A debris shield may be associated with the shaft, and may circumferentially surrounds the shaft. The debris shield may include a spiral slot, the spiral slot and the spiral groove having different pitches, wherein the actuator engages the spiral groove and the spiral slot. A wrench with one or more of these features may have a proof torque of at least the minimum level set forth in ASME B107.8, 2003 revision, when tested according to the method set forth in the ASME standard. A related method is also described.

In another embodiment, the present invention provides an adjustable wrench, comprising: a head having a first fixed jaw extending in a first direction, a pair of spaced, generally parallel, sidewalls distal from the first jaw, and a recess defined between the sidewalls; a handle extending away from the head in a second direction generally opposite the first direction and having a longitudinal axis; a second jaw selectively positionable with respect the first jaw; an adjustment mechanism controlling the positioning of the second jaw and comprising a shaft, an actuator, and a gear train operatively coupling the shaft to the second jaw; the shaft rotatably disposed at least partially in the handle and having an external spiral groove; the actuator slidable along the handle and engaging the groove; wherein the gear train comprises a worm gear rotatable about a rotational axis and disposed in the head recess; wherein the recess has a cross-sectional dimension D measured in a direction Z that is both normal to the rotational axis and generally perpendicular to the first direction; wherein the sidewalls both have a thickness in direction Z of about 25% D or more. Other features discussed above may be included in such a wrench, alone or in combination. A related method is also described.

### BRIEF DESCRIPTION OF THE DRAWINGS

FIG. 1 shows one of many embodiments of an adjustable wrench constructed in accordance with the present invention, with the jaws in the fully open position.

FIG. 2 shows a reverse perspective view of one of many embodiments of a moveable jaw.

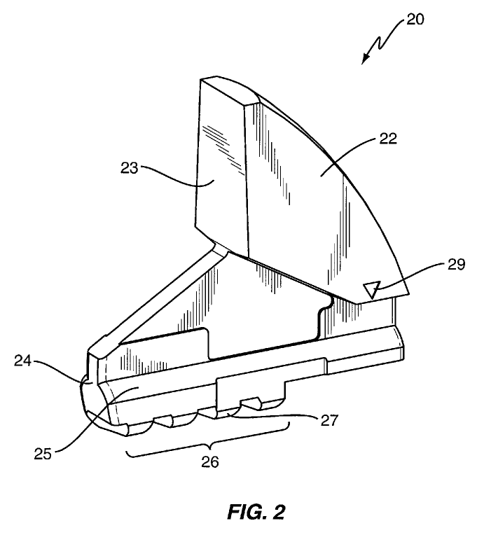

FIG. 3 shows a partially exploded view of the wrench body of FIG. 1.

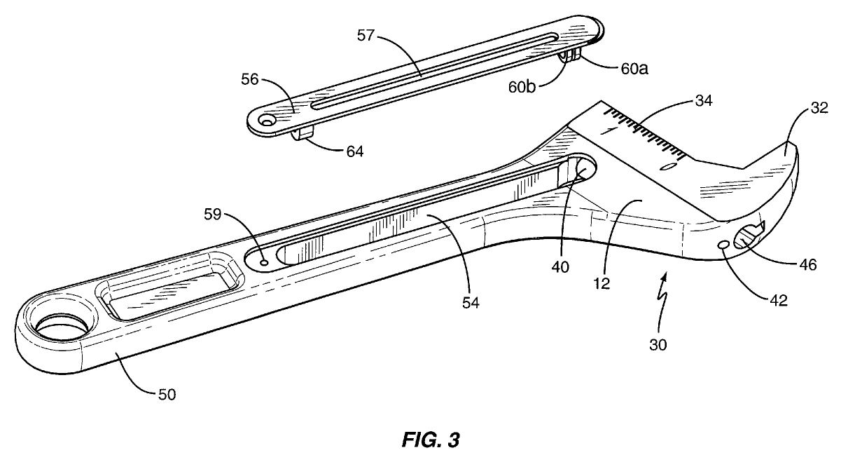

FIG. 4 shows a horizontal cross-section of the wrench of FIG. 1.

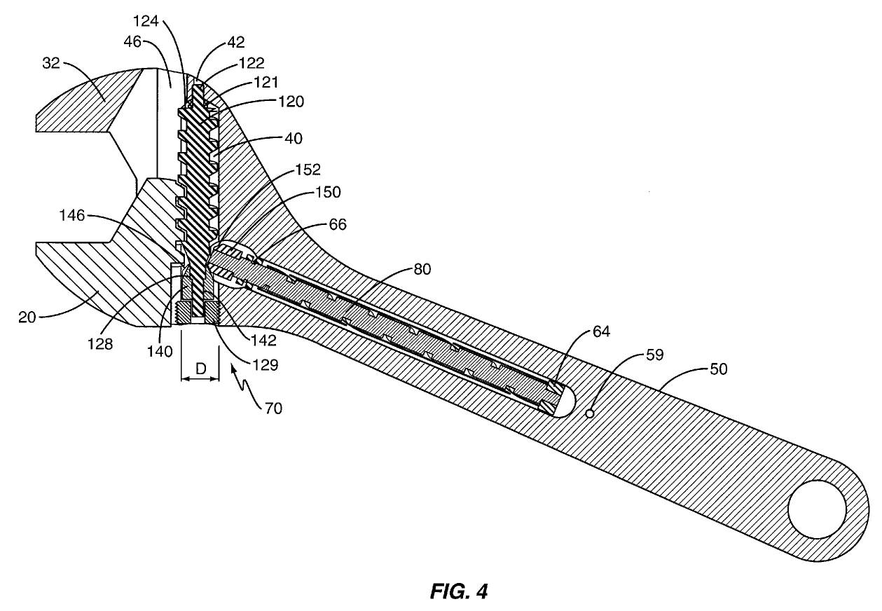

FIG. 5 shows a partial cutaway side view of the wrench of FIG. 1 with some components removed for clarity and the actuator moved to an intermediate position corresponding to the moveable jaw at a position between fully open and fully closed.

FIG. 6 shows more detail of FIG. 4.

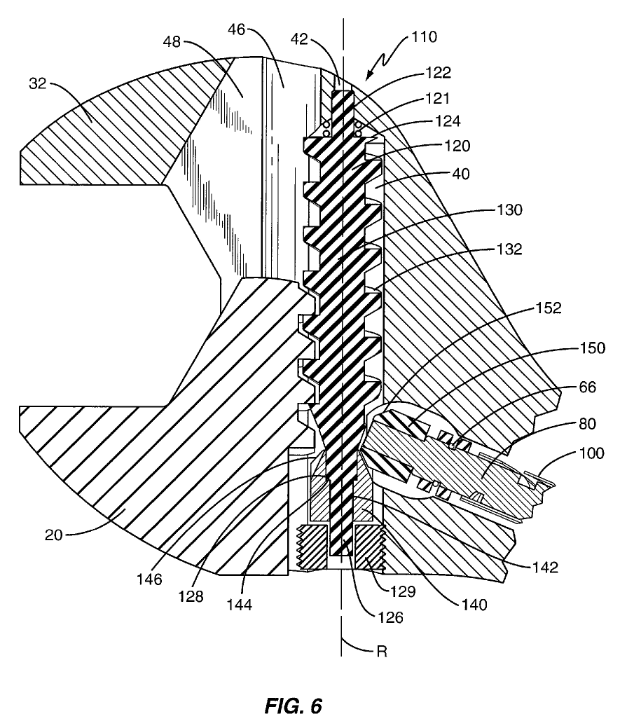

FIG. 7 shows an exploded view of the shaft portion of the adjustment mechanism, actuator, and cover plate.

### DETAILED DESCRIPTION OF THE INVENTION

The adjustable wrench of the present invention employs a slide actuated adjustment mechanism 70, and includes numerous features that may be used alone or in combination to form a robust wrench which is, in some embodiments, advantageously capable of passing the proof torque test requirement of ASME B107.8 (2003).

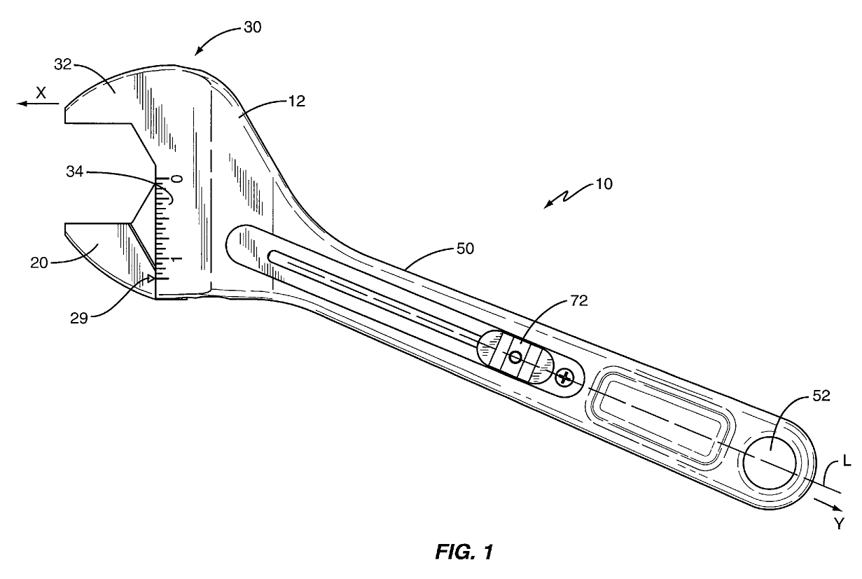

One embodiment of the wrench is shown in FIG. 1 and generally indicated at 10. The wrench includes a wrench body 12 with a jaw 20 moveably mated thereto. The wrench body 10 includes a head section 30, an integrally formed handle 50, and an adjusting mechanism 70. The head section 30 includes a fixed jaw 32 that extends forward in direction X from one lateral side portion of the head section 30, and a pair of opposing sidewalls 34a,34b that form a pair of recesses 40,46 that open to the other lateral side of the head section 30. As explained further below, the moveable jaw 20 and a worm gear 120 are mated to the head section 30 via these recesses 40,46.

The moveable jaw 20 includes a conventional jaw body 22, an intermediate web 24, and a somewhat cylindrical lower portion 25. The jaw body 22 may be of a conventional type known in the art, typically with a planar jaw face 23. The jaw lower portion 25 includes a series of teeth 27 commonly collectively referred to as a rack 26. The rack 26 is typically oriented in a direction that is perpendicular to the plane of jaw face 23. The rack 26 is somewhat larger in cross section than the intermediate web 24, so that the jaw 20 can be mounted in the wrench body 12 by sliding web 24 through slot 48 discussed further below. The fixed jaw 32 and moveable jaw 20 cooperate to form the working end of the wrench 10.

The handle 50 provides a convenient means to grip the wrench 10, and also houses a portion of the adjusting mechanism 70. The handle 50 extends away from the head section 30 in direction Y, which may be parallel to direction X or at an angle thereto. As is conventional, the handle 50 may advantageously include a hanging hole 52 toward one end. In addition, the handle 50 includes a recess 54 that is substantially covered by cover plate 56. The recess 54 is advantageously generally rectangular and oriented so that its long dimension is parallel to the handle's longitudinal axis L. One or more threaded holes 59 may be located proximate the recess 54 for securing the cover plate 56 to the remainder of the handle 50.

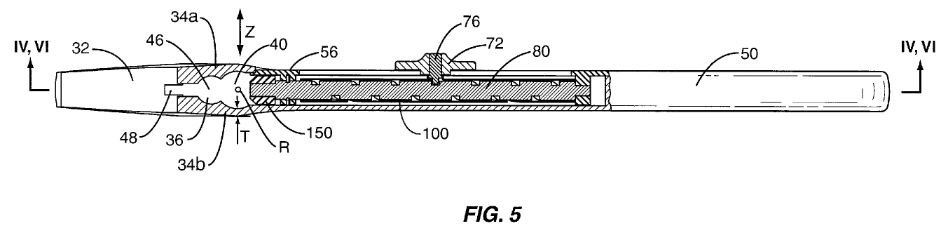

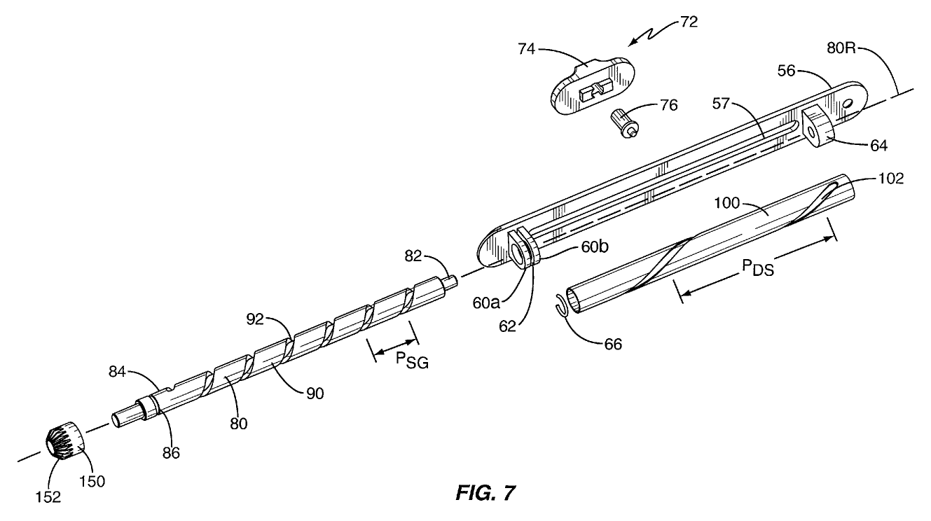

An adjustment mechanism 70 controls the positioning of the moveable jaw 20 relative to the fixed jaw 32. Broadly viewed, the adjustment mechanism 70 includes a rotatable shaft 80, an actuator 72, and a gear train 110 operatively connecting the shaft 80 to the moveable jaw 20. The shaft 80 is rotatably mated to handle 50 and disposed mostly, if not entirely, in recess 54. The shaft 80 includes a rear portion 82, a forward portion 84, and a middle portion 90. The rear portion 82 typically takes the form of a simple rod-like extension, and fits into a corresponding support 64 of handle 50. The middle portion 90 is of larger diameter, and has an spiral groove 92 in its outer surface. The spiral groove 92 extends over a substantial length of the shaft 80, and may advantageously follow a helical path about the shaft 80. The shaft forward portion 84 may have a stepped profile, with a proximal portion generally having a diameter matching the middle portion, and a rod-like distal portion of a smaller diameter that is typically longer in length than the rear portion 82. The forward portion 84 is supported by two spaced apart support flanges 60a,60b that are located some distance back from the end of the shaft 80. As seen in FIG. 5 and FIG. 7, the support flanges 60a,60b circumferentially surround the shaft 80, and therefore extend away from cover plate 52 and/or actuator 72 to a point beyond the rotational axis 80R of the shaft 80. In addition, the forward portion 84 of shaft 80 includes a circumferential recess 86 this is aligned with the gap 62 between the two support flanges 60a,60b. A retainer 66 fits between the support flanges 60a,60b to engage this circumferential recess 86. It is intended that the retainer 66 will abut against the corresponding support flanges 60a,60b to thereby limit the longitudinal movement of the shaft 80. Advantageously, the retainer 66 is appropriately sized so as to just fit between the support flanges 60a,60b, and thereby longitudinally fix the shaft 80 against longitudinal movement. The retainer 66 may take the form of a simple U-shaped wire of stiff material, a spring clip, or other suitable device that engages recess 86 on shaft 80, but allows shaft 80 to rotate about its rotational axis 80R.

An optional debris shield 100 may circumferentially surround the shaft middle portion 90 to keep external debris from entering spiral groove 92. The debris shield 100 may take the form of a simple hollow cylinder having an inner diameter greater than the outer diameter of the middle portion of shaft 80. The debris shield 100 includes a spiral slot 102 therethrough. In some embodiments, this spiral slot 102 may be helical, with a pitch PDS longer than the pitch PSG of the spiral groove 92 of shaft 80. For example, the spiral slot 102 may have a pitch that is five to six times the pitch of the spiral groove 92. The debris shield 100 fits loosely on the shaft 80, and is captured between the rearmost support flange 60b and support 64. The debris shield 100 helps cover, and thereby protect, the surface of the shaft 80, so that very little, if any, of spiral groove 92 is exposed to a potentially dirty external environment. Such an arrangement is believed to help ensure long-term smooth operation.

The actuator 72 may take the form of a simple external knob or button 74 of any convenient shape, with a downwardly extending drive peg 76. The drive peg 76, when assembled, extends through a corresponding slot 57 in cover plate 56, through spiral slot 102 if debris shield 100 is present, and into spiral groove 92. The actuator 72 may be retained with cover plate 56 by any suitable means. For example, drive peg 76 may have a thin flange proximate the underside of cover plate 56, and the button portion 74 may be pinned to the peg 76, capturing the cover plate 56 therebetween. Of course, other joining methods known in the art may be used. In addition, the button 74 may have a suitable structure on its underside to engage slot 57 in a way to prevent undesirable rotation of the button 74. The connection method should allow the actuator 72 to traverse back and forth relative to the handle 50 in what is referred to herein as a sliding motion. Note that this sliding motion does not necessarily require contact between the sliding elements. That is, the actuator button 74 may actually be suspended above the cover plate 56 (e.g., by drive peg 76) while still being considered as visually “sliding along” the cover plate 56 (and thus handle 50). Due to the inter-engagement of drive peg 76 and spiral groove 92, sliding the actuator 72 relative to handle 50 causes the shaft 80 to rotate.

The gear train 110 converts rotational movement of the shaft 80 into translational movement of the moveable jaw 20. The gear train 110, in one embodiment, includes three gears, the first of which 150 rotates with the shaft 80, and the last of which 120 engages teeth on the moveable jaw 20 to cause the jaw 20 to move back and forth. For simplicity, these gears are referred to as shaft bevel gear 150, worm bevel gear 140, and worm gear 120.

The worm gear 120 typically takes the form of an elongate body that is rotatably mounted in the wrench head section 30 with a seating portion 122, a main portion 130, and a securing portion 126. The seating portion 122 typically takes the form of a short longitudinally extending rod-shaped portion on one end of the worm gear 120. The seating portion is intended to extend into a corresponding hole 42 in the main body of the wrench head section 30 to help locate the worm gear 120. The main portion 130 of worm gear 120 includes an external helical tooth 132 that directly engages teeth 27 on the moveable jaw 120 so that when the worm gear 120 turns about its rotational axis R, jaw 20 moves. The main portion 130 has a diameter larger than the seating portion 122, thus a shoulder 124 is formed at the interface therebetween. If desired, a biasing element 121 may press against this shoulder 124 so as to urge the worm gear 120 in a direction along its rotational axis R, away from the fixed jaw 32. This biasing element 121 may take the form of a simple coil spring disposed about the seating portion 122 and captured between the head 30 and the shoulder 124, but any other biasing means known in the art may alternatively be used, including compressible washers, compressible foam, and the like.

The securing portion 126 is disposed opposite the seating portion 122. The securing portion 126 typically takes the form of a short rod-like section that has a stepped-down diameter towards its distal end to form shoulder 128. The outermost portion of the securing section 126 extends into a corresponding portion of retaining cap 129, so as to be rotatably supported thereby.

Worm bevel gear 140 is mounted on the securing portion 126, inboard of the retaining cap 129, so as to be rotationally coupled to the worm gear 120. The worm bevel gear 140 includes a central bore 142, through which the securing portion 126 extends. The central bore 142 includes an internal stepped section forming shoulder 144. It is intended that the securing portion's shoulder 128 will abut the bevel gear's shoulder 144 so as to limit the relative movement of the worm bevel gear 140 toward the main portion 130 of the worm gear 120. Advantageously, the worm bevel gear 140 is mounted so that its gear teeth 146 face inward toward the centerline of the wrench 10.

Shaft bevel gear 150 is mounted to the forwardmost portion of shaft 80 so as to rotate therewith. The teeth 152 of shaft bevel gear 150 face forward, and engage corresponding the teeth 146 on worm bevel gear 140. With this arrangement, rotational movement of the shaft 80 causes shaft bevel gear 150 to rotate, which causes worm bevel gear 140 to rotate, which causes worm gear 120 to rotate, which moves rack 26, which moves moveable jaw 20. Thus, the gear train 110 operatively couples shaft 80 to moveable jaw 20.

As noted above, worm gear 120 is mounted substantially inside head section 30 of wrench body 12. In order to accommodate this, the head section 30 includes a corresponding worm mounting recess 40. The worm mounting recess 40 may advantageously have a generally cylindrical cross section, centered on the worm gear rotational axis R. One end of the recess 40 narrows, such as via a suitable taper, to form hole 42 for accepting the seating portion 122 of worm gear 120. The other end of recess 40 helps form opening 36. An internal passage connects worm mounting recess 40 to handle recess 54, with shaft bevel gear 150 disposed in this internal passage. Head section 30 also includes another recess, known as the rack mounting recess 46, for accommodating rack 26 of moveable jaw 20. The rack mounting recess 46 includes a forwardly open (i.e., opening generally in direction X) slot 48 for accommodating moveable jaw web 24. Rack mounting recess 46 opens directly into worm mounting recess 40, so that rack 26 may engage worm tooth 132. Opening 36 is thus shaped somewhat like the numeral “8” with an upwardly extending center leg. See FIG. 5. The lower portion of opening 36 is centered about the worm gear's rotational axis R.

In operation, the movement of jaw 20 is controlled by the rotation of worm gear 120. However, unlike in conventional adjustable wrenches, the user does not directly turn the worm gear 120 to adjust the jaw spacing. Instead, the user adjusts the jaw spacing by moving actuator 72 along handle 50 in a sliding fashion. This movement causes the shaft 80 to rotate, with this rotational movement transferred to the worm gear 120 as described above.

The marketplace expects adjustable wrenches to be robust. As such, many commercial adjustable wrench products are tested against the proof torque requirements of ASME B107.8 (2003). Some embodiments of the present invention incorporate various measures, which may found alone or in combination, in order to be more robust so as to pass the proof torque requirements of ASME B107.8. One approach taken is to strengthen the sidewalls 34a,34b proximate the worm mounting recess 40 so as to help keep the worm gear 120 in better contact with the moveable jaw's rack 26 during loading. To that end, the thickness T of the sidewalls 34a,34b is increased in some embodiments. That is, if recess 40 centered about the worm gear's rotational axis R is considered to be a cylindrical bore with diameter D, then the wall thickness T of the proximate sidewalls 34a,34b should each be about ¼ D or more. This thickness is measured from the worm gear's rotational axis R radially outward in a direction Z that is both normal to the rotational axis R and generally perpendicular to direction X. This thickness T is believed to strengthen the sidewalls 34a,34b against a spreading deflection outward away from each other (up/down in the view of FIG. 5), thereby maintaining the worm gear 120 and the moveable jaw's rack 26 in proper engagement.

Another approach to making the wrench more robust, found in some embodiments, is used to help insure that the bevel gears 140,150 stay engaged. To this end, longitudinal shifting of the shaft 80 position is limited, or advantageously entirely prevented, by the interaction of retainer 66 against support flanges 60a,60b. This movement restriction helps insure that shaft bevel gear 150 does not move away from worm bevel gear 140 under load, which may otherwise occur due to the slanted gear-to-gear interaction.

The wrench 10 may be assembled in a variety of ways. In one embodiment, a forged wrench body 12 is provided that includes the handle 50, the fixed jaw 32, the sidewalls 34a,34b, handle 50, etc. In addition, shaft bevel gear 150 is attached to shaft 80, such as by press fitting and/or pinning. The shaft 80 is then fed through support flanges 60a,60b, through debris shield 100, and into support 64. During this process, the shaft 80 may need to be guided onto peg 76 of actuator 72. Then, retainer 66 is inserted into gap 62 between support flanges 60a,60b, and button 74 is affixed to peg 76, thereby joining shaft 80 to cover plate 56. Worm bevel gear 140 is joined to (e.g., press fit onto) securing section 126 of worm gear 120. Optional bias spring 121 is placed around seating section 122, rack 26 and worm gear 120 inter-engaged, and worm gear 120 inserted into worm mounting recess 40 and rack 26 inserted into rack mounting recess 46 with web 24 of moveable jaw 20 inserted into slot 48. The retainer cap 129 is then loosely screwed into wrench body 12 to retain worm gear 120. The shaft 80 assembly is then added, so that shaft bevel gear 150 engages worm bevel gear 140, and cover plate 56 is secured to handle 50 via one or more suitable screws. Note that care should be taken to have the actuator 72 in an appropriate location along shaft 80 that corresponds to the location of the moveable jaw 20. Indeed, in some advantageous embodiments, the full travel of the actuator 72 corresponds to the full travel of the moveable jaw 20, and the components should be assembled accordingly. The retainer cap 129 is then tightened and secured in place, such as by staking or glue.

The various components of the wrench may be made from any suitable materials known in the art, such as hardened steel, reinforced plastics, and the like. However, it may be advantageous for the shaft 80 and debris shield 100 to be made from brass or other materials that are easier to machine. The external portions of the wrench may be nickel chrome plated, or otherwise treated for a desirable appearance. The gears 140,150 may be metal injection molded (MIM'd) if desired with a hardness of 35-40 Rockwell C. The worm gear 120 should be formed of a suitably hard material to withstand the interactions with the teeth 27 of rack 26 under load, such as by having a hardness of about 41-47 Rockwell C, with the teeth 27 having a hardness of about 43-47 Rockwell C. In addition, the support flanges 60a,60b and support 64 may be braised to cover plate 56 if desired.

It should noted that the rack 26 of moveable jaw 20 may be shorter in length than in conventional adjustable wrenches so as to allow portions of the moveable jaw 20 to traverse beyond gear 140 for greater adjustability. Further, in some embodiments, the wrench 10 may optionally include one or more scales 34 that indicate the spacing between the jaws. A portion of such scale 34 can be on the main wrench body 12, with an indicator 29 printed or etched on moveable jaw 20. One scale 34 may be in “English” units on one face of the wrench 10 and another scale 34 may be in metric units on the opposing face of the wrench 10. Also, in some embodiments, the spiral groove 92 on the shaft 80, the bevel gears 140,150, and the tooth 132 on worm gear 120 may, if desired, be sized such that the worm gear 120 and the shaft 80 rotate the same number of revolutions for a given amount of travel by moveable jaw 20.

While the discussion above has assumed that the support flanges 60a,60b and retainer 66 are disposed between the spiral groove 92 and the shaft bevel gear 150, such is not absolutely necessary. In some embodiments, the support flanges 60a,60b and the retainer 66 may be disposed rearward of the spiral groove 92, distal from the shaft bevel gear 150. However, such arrangement is believed to be more susceptible to adverse manufacturing tolerances.

The present invention may, of course, be carried out in other specific ways than those herein set forth without departing from the essential characteristics of the invention. The present embodiments are, therefore, to be considered in all respects as illustrative and not restrictive, and all changes coming within the meaning and equivalency range of the appended claims are intended to be embraced therein.

What is claimed is:

1. An adjustable wrench, comprising:
a head having a first fixed jaw;
a handle extending away from said head;
a second jaw selectively positionable with respect said first jaw;
an adjustment mechanism controlling the positioning of said second jaw and comprising a rotatable shaft, an external actuator, and a gear train operatively coupling said shaft to said second jaw;
said shaft having an external spiral groove and rotatably disposed at least partially in said handle for rotation about a shaft rotational axis;
said actuator slidable relative to said handle and engaging said groove;
a first flange circumferentially surrounding said shaft;
a second flange circumferentially surrounding said shaft and longitudinally spaced from said first flange; and
a retainer disposed between said flanges and engaging said shaft so as to limit movement of said shaft parallel to said shaft rotational axis in two directions via abutment of said retainer with said first and second flanges.

2. The adjustable wrench of claim 1 wherein said first and second flanges are disposed between said spiral groove and said gear train.

3. The adjustable wrench of claim 1 wherein said gear train comprises a rotatable worm gear operatively disposed between said shaft and said second jaw.

4. The adjustable wrench of claim 3 further comprising a biasing member biasing said worm gear toward said shaft.

5. The adjustable wrench of claim 4 wherein said biasing member comprises a discrete spring.

6. The adjustable wrench of claim 3 further comprising a retaining cap disposed so as to constrain axial movement of said worm gear.

7. The adjustable wrench of claim 1 wherein said first jaw extends in a first direction; wherein said head further comprises a pair of spaced, generally parallel, sidewalls disposed on opposing sides of said shaft rotational axis;
further comprising a recess defined between said sidewalls; wherein said gear train comprises a worm gear disposed substantially within said recess and having a rotational axis; said recess having a cross-sectional dimension D measured in a direction Z that is both normal to said worm gear rotational axis and generally perpendicular to said shaft rotational axis; wherein said sidewalls both have a thickness in direction Z of about 25% D or more.

8. The adjustable wrench of claim 1 further comprising a debris shield associated with said shaft.

9. The adjustable wrench of claim 8 wherein said debris shield circumferentially surrounds said shaft.

10. The adjustable wrench of claim 9 wherein said debris shield includes a spiral slot, said spiral slot and said spiral groove having different pitches, wherein said actuator engages said spiral groove and said spiral slot.

11. The adjustable wrench of claim 1 wherein said shaft is substantially fixed against longitudinal movement via said first flange, said second flange, and said retainer.

12. The adjustable wrench of claim 1 wherein said wrench has a proof torque of at least the minimum level set forth in ASME B107.8, 2003 revision, when tested according to the method set forth in said ASME standard.

13. The adjustable wrench of claim 1:
wherein said first and second flanges are disposed between said spiral groove and said gear train; wherein said shaft is substantially fixed against longitudinal movement via said first flange, said second flange, and said retainer;
wherein said gear train comprises a rotatable worm gear operatively disposed between said shaft and said second jaw;
wherein said first jaw extends in a first direction; wherein said head further comprises a pair of spaced, generally parallel, sidewalls disposed on opposing sides of said shaft rotational axis and a recess defined between said sidewalls; wherein said gear train comprises a worm gear disposed substantially within said recess and having a rotational axis; said recess having a cross-sectional dimension D measured in a direction Z that is both normal to said rotational axis and generally perpendicular to said shaft rotational axis; wherein said sidewalls both have a thickness in direction Z of about 25% D or more;
further comprising a debris shield circumferentially surrounding said shaft;
said debris shield including a spiral slot, said spiral slot and said spiral groove having different pitches, wherein said actuator engages said spiral groove and said spiral slot; and
wherein said wrench has a proof torque of at least the minimum level set forth in ASME B107.8, 2003 revision, when tested according to the method set forth in said ASME standard.

14. An adjustable wrench, comprising:
a head having a first fixed jaw extending in a first direction; a pair of spaced, generally parallel, sidewalls; and a recess defined between said sidewalls;
a handle extending away from said head in a second direction generally opposite said first direction;
a second jaw selectively positionable with respect said first jaw;
an adjustment mechanism controlling the positioning of said second jaw and comprising a shaft, an actuator, and a gear train operatively coupling said shaft to said second jaw;
said shaft rotatably disposed at least partially in said handle and having an external spiral groove;
said actuator slidable along said handle and engaging said groove;
wherein said gear train comprises a worm gear rotatable about a rotational axis and disposed in said head recess;
wherein said recess has a cross-sectional dimension D measured in a direction Z that is both normal to said rotational axis and generally perpendicular to said first direction;
wherein said sidewalls both have a thickness in direction Z of about 25% D or more.

15. The adjustable wrench of claim 14 further comprising a biasing member biasing said worm gear toward said shaft.

16. The adjustable wrench of claim 14 further comprising a retaining cap mated to said head and disposed so as to constrain movement of said worm gear along said rotational axis.

17. The adjustable wrench of claim 14 further comprising a debris shield disposed about said shaft, said debris shield having a spiral slot, said spiral slot and said helical groove having different pitches, wherein said actuator engages said spiral groove and said spiral slot.

18. The adjustable wrench of claim 14 further comprising:
a first flange substantially circumferentially surrounding said shaft;
a second flange substantially circumferentially surrounding said shaft and longitudinally spaced from said first flange; and
a retainer clip disposed between said flanges and engaging said shaft so as to limit movement of said shaft parallel to said handle longitudinal axis in two directions via abutment of said retainer with said first and second flanges.

19. An adjustable wrench, comprising:
a head having a first fixed jaw;
a handle extending away from said head;
a second jaw selectively positionable with respect said first jaw;
means for adjusting the position of said second jaw relative to said first jaw; said means comprising a shaft disposed at least partially in said handle and having an external spiral groove; wherein said shaft operatively couples to said second jaw via said a gear train so as to control movement thereof;
means for limiting longitudinal movement of said shaft parallel to said axis in two directions; said means for limiting comprising at least two flanges disposed between said gear train and said spiral groove in spaced relation to each other, wherein each of said flanges circumferentially surrounds said shaft.

20. The adjustable wrench of claim 19 wherein longitudinal movement limiting means substantially fixes said shaft against movement parallel to said axis.
